(19) United States
(12) Patent Application Publication
(10) Pub. No.: US 2008/0246340 A1
(43) Pub. Date: Oct. 9, 2008

(54) Battery integrated power supply (BIPS)

(76) Inventor: Carl R. Swisher, Towanda, KS (US)

Correspondence Address: CARL R SWISHER, 10368 SW 10TH, TOWANDA, KS, 67144-9008, US

(21) Appl. No.: 11/784,266

(22) Filed: Apr. 6, 2007

(51) Int. Cl. H02J 7/00

(52) U.S. Cl. 307/66; 320/124

(57) ABSTRACT

The current state of the art in conventional direct current (DC) power supplies is to provide direct current to a load where the direct current is derived from alternating current (AC) line voltage. There are two inherent problems with such power supplies. If a large transient occurs in the line voltage it can pass through the power supply to the DC output and damage the load. The second problem is that DC power to the load is lost if AC line voltage is lost. An Uninterruptible Power Source (UPS) is sometimes used to provide power to the load in the event of loss of AC line voltage and to provide some degree of transient protection. In many cases the UPS fails to provide the required protection. The Battery Integrated Power Supply (BIPS) circuit claimed in this application provides isolation between the load and the line to minimize damage due to transients and also provides an inherent UPS function.

### CROSS REFERENCE TO RELATED APPLICATION

Not Applicable

### FEDERALLY SPONSORED R & D

Not Applicable

### SEQUENCE LISTING

Not Applicable

### BACKGROUND OF THE INVENTION

The need for this invention was first determined when the applicant was designing battery backed up power supplies for classified communications equipment in the 1970's. The equipment would switch to battery backup when line voltage was lost and in many cases the battery would have failed while in standby and would not provide the desired backup time. In addition, the units were failing in service due to damage from transients occurring in line voltage. The BIPS circuit was conceived during this period but contract constraints did not allow time or money for development.

The need for this invention was further determined in the 1980's when the applicant was utilizing off the shelf computers in computer controlled data acquisition systems that were being installed on deep well gas drilling rigs in Louisiana, Texas and Oklahoma. These units were experiencing severe failure rates due to transients induced into the line voltage by proximity lightning and large SCR houses that provided site power from diesel electric generators. Every attempt was made to protect the equipment by purchasing off the shelf equipment, such as commercially available Uninterruptible Power Sources (UPSs) that were intended to protect the computers from transient damage and provide battery backup. However, in many cases the off the shelf equipment failed in service and did not provide adequate protection.

No time was available to develop and incorporate the BIPS circuits as the oil and gas drilling business went into steep decline and most service companies went into bankruptcy.

After retirement in 1993 the applicant designed a prototype circuit that utilized the BIPS concept. The circuit was fabricated and placed under test in June of 1996. An Engineering notebook is available to review the prototype circuit and the test results. The project was put on hold at the completion of the initial testing due to conflict of interest. The project was revived in March of 2006 and the prototype was put back in service and testing resumed with new batteries.

Before initiating this patent application the applicant interviewed several individuals who were responsible for providing contract maintenance for large computer installations to determine if they concurred that damage due to transients induced by proximity lightning was a significant problem. In all cases, these individuals concurred that the dollar loss to hardware was significant; however they also pointed out that the dollar loss due to downtime was even more significant and could run into thousand and tens of thousands of dollars an hour in large fully automated Computer Aided Manufacturing facilities.

### REFERENCES CITED

Not Applicable

### BRIEF SUMMARY OF THE INVENTION (REFER TO FIG. a.0)

The intent of the BIPS circuit is to provide DC power for electronic equipment by utilizing a pair of batteries (BA1 AND BA2) so that the load is isolated from line voltage at all times in order to minimize damage due to transients induced in line voltage by proximity lighting or other sources of high energy transients. The BIPS circuit also provides an inherent UPS function.

At the start up of the BIPS circuit BA2 is powering the load while BA1 is being charged. The batteries are then briefly connected in parallel to maintain power to the load and the batteries are then switched so that BA1 powers the load while BA2 is being charged.

The BIPS circuit switches the batteries between charge and usage on a continuous basis so that both batteries are maintained at near full charge.

The BIPS circuit provides high impedance isolation between the line and the load by switching both positive and ground sides of the batteries to prevent transients occurring in the line from being coupled to the load. Transients that do occur will be suppressed by the low impedance of the battery being charged.

By maintaining both batteries at near full charge the BIPS circuit inherently provides the UPS function so that the load can continue to operate if line voltage is lost or if the operator desires to operate in the battery only mode. When line voltage is lost the BIPS circuit continues to alternately switch the batteries so that the load continues to be powered by the batteries to the extent the ampere-hour capacity of the batteries allows. When line voltage is restored alternate recharging of both batteries is resumed.

By utilizing two batteries and alternately switching the batteries between charge and usage, the load is maintained isolated from damaging transients that might occur in the line voltage. Such transients are a primary cause of failure in electronic circuits that are connected to line voltage. Thus the BIPS circuit provides the same degree of transient protection to electronic circuits that would be provided if they were operated on a single battery and not connected to line voltage.

### BRIEF DESCRIPTION OF DRAWINGS

FIG. a.0 BIPS Prototype—Schematic Diagram

FIG. a.1 BIPS Prototype—Charging Circuit

FIG. a.2 BIPS Prototype—Load Circuit

FIG. a.3 BIPS Prototype—Timing Circuit

FIG. a.3.1 BIPS Prototype—Timing Circuit Bill of Materials, MSMV Pin outs and Timing

FIG. 1 Relay Contacts—Off Mode

FIG. 2 Relay Contacts—Pre-Charge Mode

FIG. 3 Relay Contacts—Operate Mode State 1

FIG. 4 Relay Contacts—Operate Mode State 2 (& 4)

FIG. 5 Relay Contacts—Operate Mode State 3

### DETAILED DESCRIPTION OF THE INVENTION

The BIPS circuit is expected to have application with many electronic devices that would utilize a direct current (DC) power supply where it is desired to provide isolation between the line and the load (to minimize or eliminate damage due to severe transients) and it is further desired to provide battery backup capability in case of loss of line voltage or if the operator wishes to operate the device in the battery only mode.

It is expected that the BIPS circuit will be implemented in many different configurations, dependent upon the specific application. A few specific applications would be Battery Integrated Power Supply circuits for computers in many configurations (Laptop, Desktop, Engineering Work Stations, and Industrial), Programmable Logic Controllers, Audio and Video equipment, Medical equipment, Test equipment, Instrumentation, etc.

The basic concept of the BIPS circuit might also have applications where it may be desired to protect a large facility from damage due to lightning induced transients and also provide some degree of UPS function. In these cases the function would be AC/DC/AC conversion where output voltage would be the same as the input voltage but the output would be isolated from the input by the BIPS circuit and the dual batteries in the BIPS circuit would provide the UPS function.

A BIPS circuit for other applications would have timing and switching circuits that would function in the same manner as the prototype shown in FIG. a.0, however components would be of different ratings dependent upon the application. Applications that might have a variable load would require a variable rate charging system in order to avoid over or undercharging the batteries. However such variations in circuit implementation to fit specific applications will be within the current state of the art and will not represent a deviation from the basic concept of the BIPS circuit.

Manner and process of making and using the BIPS circuit and purpose of the BIPS circuit.

For purposes of prototype evaluation a BIPS circuit was fabricated and utilized as the power supply for a laptop computer. (This would be considered a typical application; however there will be significant other applications for the BIPS concept.)

In a normal desktop computer, transients occurring on the line voltage supplying power to the computer can and do cause significant damage to the computer; sometimes to the extent that lightning induced transients can totally destroy the CPU chipset on the motherboard. In addition, loss of line voltage results in the computer being shutdown. In an attempt to minimize damage due to transients and to provide backup power, computer users often resort to installing Uninterruptible Power Sources (UPSs).

These UPSs have limited transient protection and often fail in service because the backup battery has failed and this is not known until the unit is placed in service.

The case of a laptop computer is somewhat different. The laptop is inherently isolated from line voltage transients when it is operating on battery. A laptop needs no UPS function since loss of line voltage does not shutdown a laptop when it is operating on battery.

However, laptops are normally operated connected to line voltage by a charging circuit similar to a DC power supply so that the battery is maintained in a fully charged condition. Thus, when laptops are connected to line voltage they are subject to damage due to transients occurring in line voltage and often require the installation of an UPS in an attempt to minimize damage due to transients.

In addition, the external UPSs that are installed between line voltage and computers represent a cost redundant to the cost of the power supply provided with the computer. (Either the internal power supply for a desktop or the external charging circuit for a laptop.).

Implementing the power supply of a desktop computer, a laptop computer or other electronic devices with a BIPS circuit would not represent a redundant cost since the BIPS circuit will be the only power supply and no redundant UPS will be required.

If the power supply for a laptop computer, a desktop computer or other electronic device, were fabricated utilizing the BIPS circuit then the devices would be isolated from transients occurring in line voltage at all times. In addition, battery backup is inherent in the BIPS circuit so that normal operation would continue if the line voltage is lost or if the operator wishes to disconnect from line voltage and operate the device in the battery only mode.

A prototype BIPS circuit has been fabricated and tested utilizing circuits as shown in FIG. a.0 in order to validate the concept. The prototype BIPS circuit was utilized to replace the battery pack and external charging circuit for a laptop. For test purposes no attempt was made to package the BIPS circuit in the laptop. The unit was fabricated and tested on a breadboard external to the laptop but connected to the laptop by using a dummy battery pack. (FIG. a.2)

A typical laptop has a battery pack that provides 14.4 Vdc at 4.4 AH. The prototype BIPS unit has two 14.4 Vdc batteries at 2.2 AH each thus providing 4.4 AH of back up capability. The charging circuit for the BIPS is similar to the charging circuit for a typical laptop in that it would provide the necessary voltage and current required to maintain the two batteries in near fully charged condition.

The switching circuit for the prototype BIPS unit was implemented with off the shelf reed relays.

The timing circuit needed to operate the prototype BIPS was implemented with standard TTL logic devices.

All of the devices for the prototype BIPS circuit are common, off the shelf devices and the circuits are standard logic design practice. What is unique about the BIPS circuit is the method of operation (continuously switching batteries between use and charge) that maintains the two batteries in the near full charge condition and keeps the load isolated from line voltage at all times, thus providing the isolation and battery back up capability claimed.

In the case of the prototype BIPS it was not necessary to utilize a complex battery management system since the laptop presented a near constant load to the batteries. The only requirement was to maintain a near full charge on the batteries without overcharging and provide a charge rate sufficient to replace the energy utilized as each battery is connected to the load.

For the prototype a standard off the shelf 0 to 20 Vdc 10 amp adjustable voltage power supply was used to set at a constant recharge current of 125% of the load current. (FIG. a.1)

BIPS Prototype—Schematic Diagram (Refer to FIG. a.0)

FIG. a.0 shows interfaces to a charging circuit, a timing circuit and a laptop computer as a load circuit. The remainder of FIG. a.0 is the actual detailed schematic diagram of the BIPS circuit as it was implemented for the prototype.

The essential components of the BIPS prototype schematic are:
Two batteries, BA1 and BA2
Four relay functions, K1, K1A, K2 and K2A

For the prototype the relay functions were implemented with reed relays. Since two poles are required for each relay function two reed relays were connected with their coils in parallel to function as a double pole relay with two Normally Open (NO) contacts. The relay coils are wired in parallel with LEDs' for visual indication of relay operation. A diode is also wired in parallel with each relay coil to suppress the transient caused when the relay coils are opened.

The relay coils are operated in sequence by TTL outputs (Vcc=5 Vdc) from the timing circuit. Details of the timing circuit will be covered in the discussion of FIG. a.3 (Para. 11.0)

TTL logic level driven reed relays were used to implement the switching function. Future implementations of the BIPS circuit could utilize other switching devices such as TTL driven MOSFETS (or equiv.) in place of the 8 relays shown in FIG. a.1. Other applications might utilize other switching devices such as mercury wetted relays, etc. Regardless of implementation, the switching function and the timing relationship will remain the same.

NICAD batteries were used to implement the batteries for the prototype. Future implementations would utilize battery types and sizes as needed for the specific application. Typical laptop batteries utilize Lithium Ion cells since they provide the highest current density for their size, which is important in laptops.

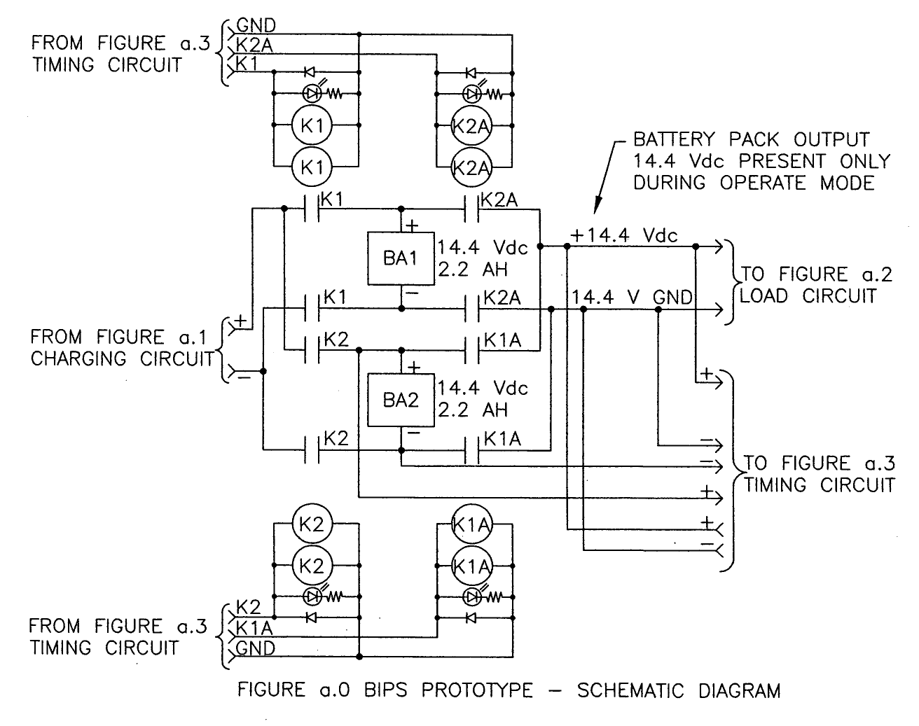

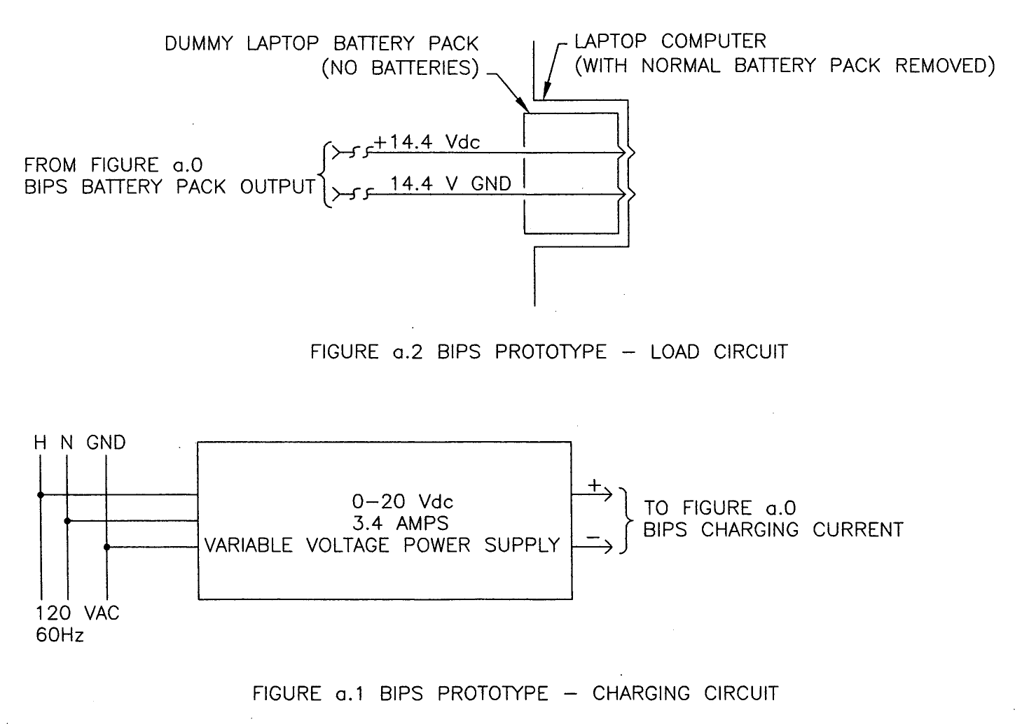

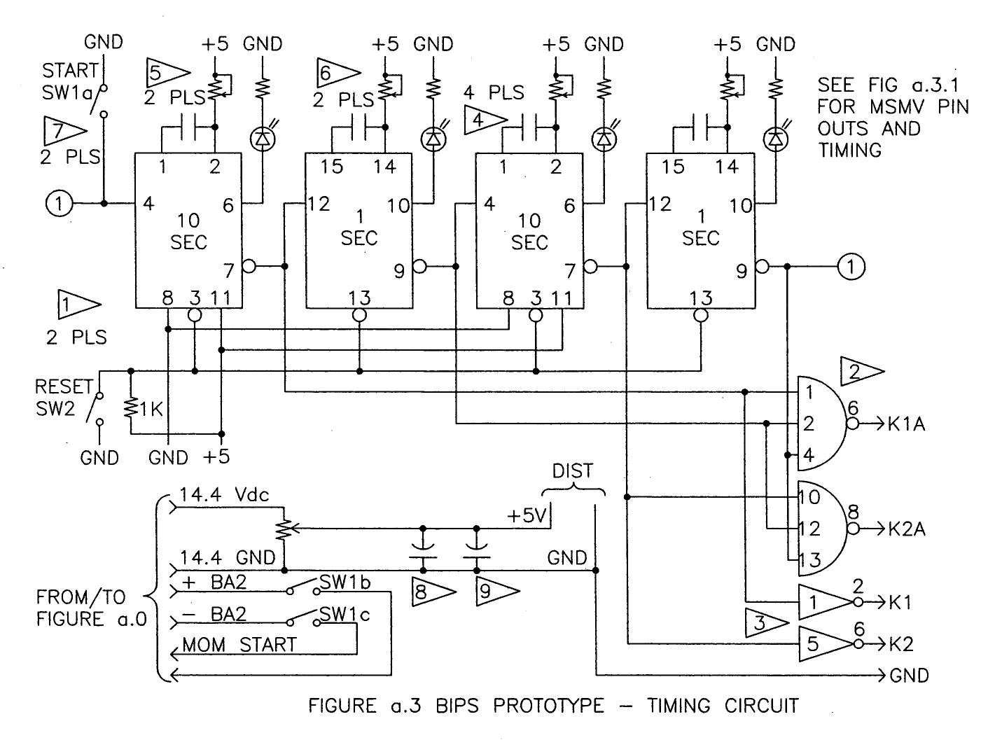

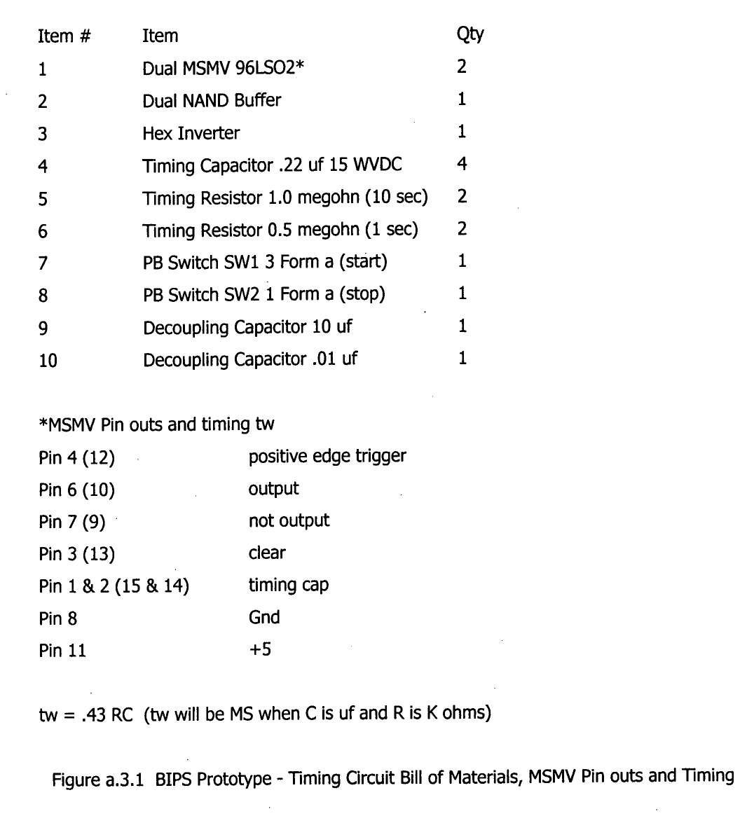

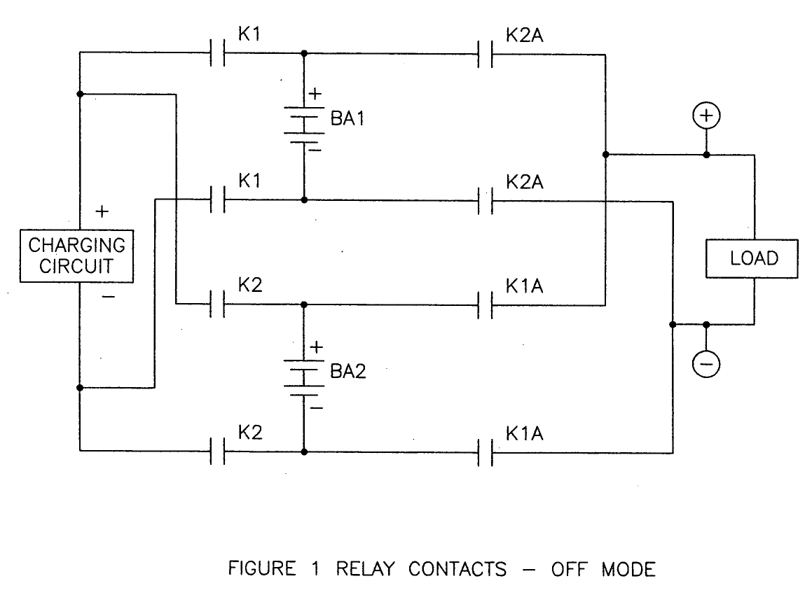

Operational Sequence (Refer to FIGS. 1-5)

FIGS. 1-5 are used for the initial discussion of the BIPS circuit and its operational sequence. In these figures only the relay contacts are shown. The discussion of the condition of the relay contacts provides a very simple understanding of the operation of the BIPS concept. The BIPS circuit operates in an OFF MODE, a PRE-CHARGE MODE and four repetitive sequential operating states. For purposes of initial discussion of the BIPS schematic diagram assume that the 5 Vdc timing signals K1, K1A, K2, and K2A, which operate the relays (and their contacts) are provided manually. (Derivation of the actual timing signals is discussed in detail in Para. 11.0)

FIG. 1 shows the BIPS circuit in the OFF MODE. (Note that all relay contacts are open.)

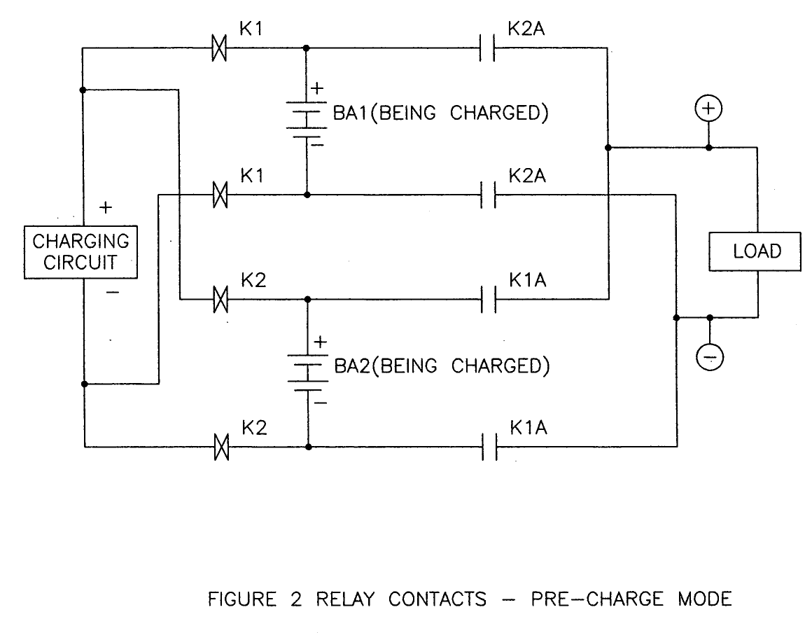

FIG. 2 shows the BIPS circuit in a PRE-CHARGE MODE. Relay contacts K1 (2ea) and K2 (2ea) would be closed to pre-charge the batteries BA1 and BA2 to an initial full charge condition. (Neither battery is connected to the load in this mode.)

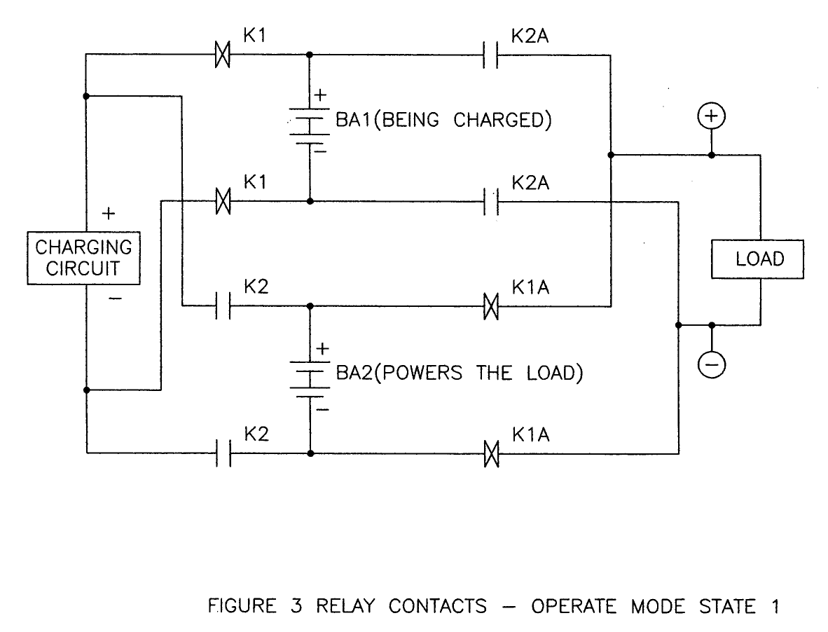

FIG. 3 shows the BIPS circuit in the OPERATE MODE—State 1. In State 1 a timing signal 5 Vdc is applied to relay coils K1 and K1A which closes the two K1 NO contacts and the two K1A NO contacts. This state connects BA1 to the charging circuit and BA2 to the load. (Note that in State 1 the load is completely isolated from the line and is connected only to BA2. Only BA1 is connected to the charging circuit.) The circuit is left in State 1 until BA2 is discharged to a predetermined level. (With a constant load this level can be determined by time.)

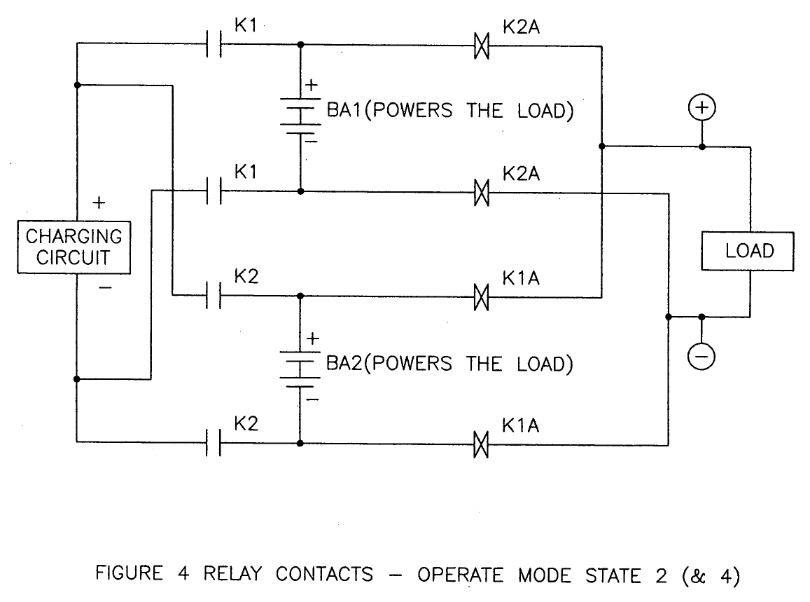

FIG. 4 shows the BIPS circuit in the OPERATE MODE—States 2 (and 4). When the predetermined level of discharge is reached, (assume 90%), the circuit advances to State 2. In State 2 5 Vdc is removed from relay coil K1 and is applied to relay coil K2A. 5 Vdc remains connected to relay coil K1A, thus in State 2 relay contacts K2A and K1A are all closed which connects both batteries BA1 and BA2 in parallel to the load and both batteries are disconnected from the charging circuit. (Note that in State 2 the load is completely isolated from the line and BA2 remained connected to the load while BA1 was being connected in parallel, thus maintaining battery power to the load during the switching operation.) The circuit is left in State 2 only long enough for BA1 to be disconnected from the charging circuit and connected in parallel with BA2 to the load.

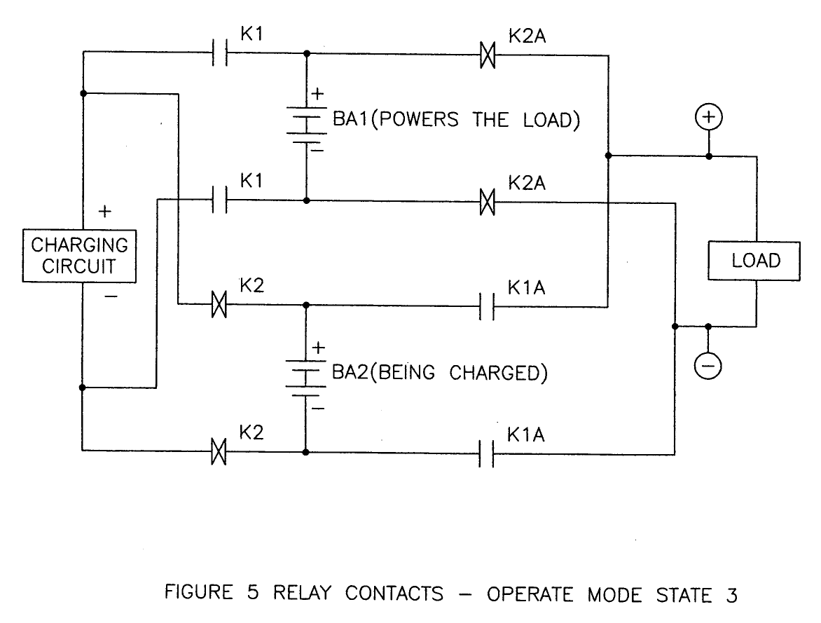

FIG. 5 show the BIPS circuit in the OPERATE MODE—State 3. The circuit then advances to State 3. In State 3 5 Vdc is applied to relay coils K2 and K2A which closes the two K2 NO contacts and the two K2A NO contacts. State 3 connects BA2 to the charging circuit and BA1 to the load. (Note that in State 3 the load is completely isolated from the line and is connected only to BA1. Only BA2 is connected to the charging circuit.) The circuit is left in State 3 until BA1 is discharged to a predetermined level. (With a constant load this level can be determined by time.)

FIG. 4 shows the BIPS circuit in the OPERATE MODE—States 4. When the predetermined level of discharge is reached, (assume 90%) the circuit advances to State 4. In State 4 5 Vdc is removed from relay coil K2 and is applied to relay coil K1A. 5 Vdc remains connected to relay coil K2A thus in State 4 relay contacts K2A and K1A are all closed which connects both batteries BA1 and BA2 in parallel to the load and both batteries are disconnected from the charging circuit. (Note that in State 4 the load is completely isolated from the line and BA1 remained connected to the load while BA2 was being connected in parallel, thus maintaining battery power to the load during the switching operation.) The circuit is left in State 4 only long enough for BA2 to be disconnected from the charging circuit and connected in parallel with BA1 to the load.

The timing then returns to OPERATE MODE—State 1. (FIG. 3) The timing would then continue the sequential operation of: State 1, State 2, State 3, State 4, State 1, State 2, State 3, State 4, etc.

The time periods for States 1 and 3 would be such that neither battery is discharged a significant amount before it is disconnected from the load and placed on the charging circuit. Thus both batteries are maintained at a high percentage of charge so that both batteries can provide backup power to the load in the event of loss of line voltage.

States 2 and 4 are of short duration so that the switchover between BA1 and BA2 can occur while still providing power to the load.

In the event of loss of line voltage States 1-4 continue the normal operation of switching BA1 and BA2 between the charging circuit and the load. The batteries are not being recharged during the period of loss of line voltage. When line voltage returns, normal charging resumes in States 1 & 3. Thus the BIPS circuit inherently functions as an UPS.

By observing the simplified schematic diagrams in FIGS. 3, 4 and 5 it can be seen that the BIPS circuit provides isolation between line voltage and the load so that the possibility of damage to the load circuit due to transients occurring in the line voltage is greatly reduced or eliminated since the load is powered by isolated batteries at all times.

BIPS Prototype—Charging Circuit (Refer to FIG. a.1)

For the prototype the charging circuit was implemented with an off the shelf variable output voltage DC power supply providing 0 to 20 Vdc 3.4 amps. The output was set to a constant voltage to produce sufficient current to maintain near full charge to the batteries during operation.

The load presented to a typical laptop computer's battery pack is a nominal 500 milliamps (ma). The BIPS recharge circuit was set to a recharge rate of 125% of usage rate or 625 ma.

The charging circuit provides essentially the same function as the external recharging circuit utilized in laptop computers when they are connected to line voltage.

Future implementations of the BIPS charging circuit would require specific circuits to fit the application. Such variations in implementation to fit specific applications will not represent a deviation from the basic concept of the BIPS circuit.

BIPS Prototype—Load Circuit (Refer to FIG. a.2)

The load circuit for the BIPS prototype is a laptop computer with its normal battery pack replaced by a dummy battery pack that is connected to the output of the BIPS batteries.

The two 14.4 Vdc 2.2 AH prototype BIPS batteries will provide the same output to the load as the typical laptop battery pack. (14.4 Vdc 4.4 AH) Future implementations of the BIPS circuit would present specific individual load requirements which would result in specific battery requirements. Such variations in requirements will not represent deviations from the basic concept of the BIPS circuit.

BIPS Prototype—Timing Circuit (Refer to FIG. a.3)

FIG. a.3 shows the schematic diagram of the timing circuit utilized in the prototype to produce the 5 Vdc timing signals required to sequentially step the BIPS circuit though its four operational states. (States 1-4)

The circuit in FIG. a.3 was implemented with off the shelf TTL logic devices in a hardwired configuration. Future implementations will provide the same sequential steps but could be implemented with programmable devices such as PLD's, PLA's etc. in order to avoid the complicated wiring required for the TTL devices and to allow programming changes to be made in firmware or software. Such variations in the implementation of the timing circuit will not represent deviations from the basic concept of the BIPS circuit.

The timing increments utilized for the prototype were:

| | |
|---|---|
| State 1 | 10 seconds |
| State 2 | 1 second |
| State 3 | 10 seconds |
| State 4 | 1 second |

Selection of these timing increments was based on the desire to maintain the batteries to between 90% and 100% of full charge with no overcharge or undercharge. The BIPS circuit was operated in this manner for several weeks during prototype testing. Near full charge condition was demonstrated by disconnecting BIPS from line voltage and observing the batteries provide the UPS function for the time expected based on the batteries rated AH capacity.

Future implementation of the BIPS timing circuit will require that the time periods of States 1-4 be based on the specific application; however the 4 state sequences will be retained. Such variations in the times of States 1-4 to suit the specific applications will not represent deviations from the basic concept of the BIPS circuit.

Detailed discussion of BIPS Prototype Timing Circuit Logic Implementation

The prototype timing circuit was implemented with 4 monostable multivibrators (MSMV's), (also called one-shots), 2 NAND gates and 2 inverters. The one-shots are operated as an asynchronous ring counter in a repeating sequential mode: 10 second, 1 second, 10 second, 1 second, etc.

A momentary switch (SW1a) sets the first one-shot to a logic 1 to START the counter and another momentary switch (SW2) resets (STOPS) the counter. Once started, the counter continues the sequencing of logic 1 from one-shot to one-shot until the counter is reset by SW2. (Also see Para. 12.5)

The four one-shot outputs are matrixed by the NAND gates and the inverters to produce the timing signals K1, K1A, K2 and K2A. These 5 Vdc timing signals are connected to relay coils K1, K1A, K2 and K2A (shown in FIG. a.0) which in turn produce the relay contact closures required to operate the BIPS circuit sequentially. LEDs are connected to the output of each one-shot for a visual indication of the timing sequence.

The four states and relay contact closures are shown below:

Relay Contact Closure States (timing signals)
(C = CLOSED CONTACT, O = OPEN CONTACT)

| STATE | K1 | K1A | K2 | K2A | Condition |
|---|---|---|---|---|---|
| 1 | C | C | O | O | BA1 charge, BA2 in use (10 seconds) |
| 2 | O | C | O | C | BA1 in use, BA2 in use (1 second) |
| 3 | O | O | C | C | BA1 in use, BA2 charge (10 seconds) |
| 4 | O | C | O | C | BA1 in use, BA2 in use (1 second) |

(FIGS. 3–5 also show these relay contact closures in schematic form)

The supply voltage required to operate the timing circuit (Vcc=nominal 5 Vdc) is derived from the 2 BIPS batteries. This allows the timing circuit to operate independent of line voltage. Before SW1 is depressed to start the timing circuit there is no voltage at the output of the BIPS batteries since relays K2A and K1A are open.

To provide the initial 5 V supply voltage needed to operate the timing circuit the START switch on FIG. a.3 (SW1b and SW1c) momentarily applies BA2's voltage to the output of the batteries on FIG. a.0. This provides 14.4 Vdc to the voltage divider shown in FIG. a.3, as long as SW1 is depressed. The momentary output of the voltage divider provides the initial 5 V required to operate the timing circuit's TTL devices. As SW1b and SW1c are depressed, SW1a simultaneously sets the first one-shot in the ring counter to logic 1 to start the timing sequence. Once the timing circuit is in State 1 the output of BA2 is applied to the output of the BIPS batteries for 10 seconds when K1A contacts are closed. Once the timing sequence is started it continues to sequence through States 1-4 and 14.4 Vdc is provided continuously to the input of the voltage divider and the output of the voltage divider provides the 5 V supply voltage for the timing circuit.

The timing circuit and the momentary start circuit described above are for prototype demonstration only. Future applications of the BIPS circuit will utilize some form of programmable device (PLA or PLD) to produce the required timing and start sequences or the timing and start circuits might be incorporated as part of a large scale integration of the BIPS circuit components.

### ABBREVIATIONS

### AC Alternating Current

### AH Ampere Hour

### BA Battery

### BIPS Battery Integrated Power Supply

### C Normally Open Relay Contact Closed

### DC Direct Current

### K Relay Designation

### LED Light Emitting Diode

### MOSFET Metal Oxide Silicon Field Effect Transistor

### MSMV Monostable Multivibrator

### NAND Not And

### NC Normally Closed

### NICAD Nickel Cadmium

### NO Normally Open

### O Normally Open Relay Contact Open

### PLA Programmable Logic Array

### PLD Programmable Logic Device

### SCR Silicon Controlled Rectifier

### TTL Transistor Transistor Logic

### UPS Uninterruptible Power Source

### Vcc Supply Voltage (TTL Logic)

Vdc Volts, direct current

I claim:

1. A battery integrated power supply circuit, comprising a plurality of two batteries, a network of switching functions and a timing sequence that operates said switching functions in a manner that maintains one said battery connected to a load while the other said battery is connected to a charging current and alternately switches said batteries between said load and said charging current.

2. The said battery integrated power supply circuit in claim 1 maintains one or both said batteries connected to said load at all times and when both said batteries are momentarily connected to said load then neither said battery is connected to said charging current.

3. The said battery integrated power supply circuit in claim 1 allows said charging current to alternately maintain the plurality of said batteries to near full charge when said charging current is present.

4. The plurality of said batteries in claim 1 remains alternately connected to said load during temporary loss of said charging current and the said battery integrated power supply circuit resumes recharging of said batteries to near full charge when said charging current is restored.

5. A battery integrated power supply circuit comprising a plurality of two or more batteries, a network of switching functions and a timing sequence that operates said switching functions in a manner that maintains one said battery connected to a load while the other said battery is connected to a charging current and alternately switches said batteries between said load and said charging current and maintains isolation between said line and said load thus reducing the possibility of damage to said load by transients induced in said charging current by proximity lightning or other sources of high energy transients.

6. The said battery integrated power supply circuit in claim 5 continues to alternately connect said plurality of said batteries to said load during temporary loss of said charging current so that the said battery integrated power supply circuit functions as an uninterruptible power source to maintain power to said load to the extent that the ampere-hour capacity of the batteries allows.

7. The said battery integrated power supply circuit in claim 5 maintains the plurality of said batteries alternately connected to said charging current source so that alternately charging of the plurality of said batteries resumes when said charging current is restored.

8. The said battery integrated power supply circuit in claim 5 provides electronic devices with the same degree of protection against damaging transients as if the said devices were battery operated.

9. Transients that do occur in said charging current of said battery integrated power supply in claim 5 will be suppressed by the low impedance of said battery or batteries being charged by said charging current and will not be detrimental to said load which is isolated from transients occurring in said charging current.

10. Transients that occur in said charging current of said battery integrated power supply in claim 5 when both said batteries are connected in parallel to said load will not be detrimental to said load which is isolated from said charging current since both said batteries are not connected to said charging current.
